(19) United States
(12) Patent Application Publication
(10) Pub. No.: US 2024/0338283 A1
(43) Pub. Date: Oct. 10, 2024

(54) METHOD FOR ESTABLISHING BYZANTINE FAULT TOLERANCE FOR A STATE MACHINE REPLICATION SYSTEM

(71) Applicant: VMware, Inc., Palo Alto, CA (US)

(72) Inventors: Teodor PARVANOV, Sofia (BG); Jonathan HOWELL, Seattle, WA (US); Hristo STAYKOV, Sofia (BG); Nikolay Kolev GEORGIEV, Sofia (BG); Oded Tzvi PADON-CORREN, Albany, CA (US)

(21) Appl. No.: 18/296,317

(22) Filed: Apr. 5, 2023

(51) Int. Cl. G06F 11/16

(52) U.S. Cl. CPC G06F 11/1658; G06F 2201/805

(57) ABSTRACT

The disclosure provides an approach for formally verifying a state machine replication protocol (SMRP) based on a model SMRP, and deploying a distributed system, such as a blockchain, that runs using the formally verified SMRP. The approach provides a verifier that models the SMRP within a model distributed system. Modeling includes modeling actions by model components of the model distributed system so as to transition state of the model SMRP, and then verifying that applicable invariants hold true after the state transition. As long as the model and actual SMRPs are logically equivalent, then launching an actual SMRP based on the model SMRP should preserve formally verified byzantine fault tolerance within the actual SMRP of the distributed system.

### BACKGROUND

Byzantine fault tolerant (BFT) protocols are used to build replicated services in distributed systems. Recently, they have received revived interest as the algorithmic foundation of what are known as decentralized/distributed ledgers, or blockchains, such as those used for Bitcoin, Ethereum, or Solana transactions.

In conventional approaches to BFT protocol designs, a protocol designer or a service administrator first picks a set of assumptions (e.g., the fraction of Byzantine faults and certain timing assumptions) and then devises a protocol (or chooses an existing one) tailored for the particular set of assumptions. The assumptions made by the protocol designer are imposed upon all parties involved, including every replica maintaining the service as well as every client using the service. Such a protocol collapses if deployed under a set of assumptions that differ from the one it is designed for. In particular, optimal-resilience of asynchronous or partially synchronous solutions completely break down and provide inaccurate results if the fraction of Byzantine or faulty replicas exceeds ⅓ of total replicas (“N=3F+1”). Similarly, optimal-resilience synchronous solutions break down and provide inaccurate results if the fraction of Byzantine or faulty replicas exceeds ½ of total replicas or if the synchrony bound is violated (“N=2F+1”).

Byzantine replicas are capable of behaving arbitrarily, such that a Byzantine replica may output one result to one replica in a group of replicas, or it may output a different result to another replica in the group of replicas, or in an attempt to corrupt the replicated service, it may not output any result to yet another replica in the group of replicas.

Byzantine faults are notoriously difficult to test. A BFT protocol's main guarantee is that it ensures consistency even in the face of up to one-third of the participating replicas acting arbitrarily (Byzantine), including adversarial behavior. Establishing this guarantee using testing is infeasible, because in addition to the combinatorial explosion of nondeterministic scheduling and network failures of any asynchronous system, one must also consider every possible behavior from the Byzantine replicas. The difficulty is further compounded when various optimizations are needed to meet the customer expectations for performance while maintaining correctness and security. If not done carefully, optimizations can cause subtle deviations from the true specification of the system and testing alone cannot guarantee success.

Formal modeling methods for verifying program correctness are usually viewed as a complicated and ineffective approach for real word systems. Although formal modeling methods for verifying program correctness are usually viewed as a complicated, with the increasing complexity of distributed systems, there is an initiative to explore the potential benefits of formal modeling for designing and deploying distributed systems. While in traditional testing, a model distributed system performs given actions that trigger certain code paths in a tested executable, in formal modeling and verification, a model distributed system has first order logic that describes how an executable transitions from one state to the next based on a finite set of actions, and state invariants must be preserved on each state transition. When a model distributed system transitions, the model distributed system considers all possible states for which the invariants hold, and checks that no matter which action from the selected set also preserves the stated invariants. This information is passed to an automated theorem prover, and it reasons if statements are logically correct. Thus, once a verifier of a model distributed system receives validation from the theorem prover, formal modeling and verification provides the highest degree of certainty that the model is correct and preserves safety without the need to actually perform any test scenarios.

### SUMMARY

Embodiments provide a method of deploying a distributed system that implements a state machine replication protocol, the method comprising: simulating a model distributed system that implements a first state machine replication protocol; choosing an action by one of model components of the model distributed system to cause a state transition of the model distributed system; verifying the first state machine replication protocol by verifying that one or more invariants are true in the model distributed system after the state transition; creating a map connecting actions of the first state machine replication protocol and lines of code of a second state machine replication protocol; deploying a distributed system that implements the second state machine replication protocol; and referencing the map to either (a) modify the second state machine replication protocol responsive to one or more changes in the first state machine replication protocol, or (b) modify the first state machine replication protocol responsive to one or more changes in the second state machine replication protocol.

Further embodiments include a non-transitory computer-readable storage medium storing instructions that, when executed by a computer system, cause the computer system to perform the method set forth above, and a computer system programmed to carry out the method set forth above.

### BRIEF DESCRIPTION OF THE DRAWINGS

FIG. 1 depicts a block diagram of a computer system in which one or more embodiments of the present disclosure may be utilized.

FIG. 2 depicts a block diagram of a distributed system, according to an embodiment.

FIG. 3 depicts a block diagram of a verifier, according to an embodiment.

FIG. 4 depicts a flow diagram of a method of formally verifying byzantine fault tolerance of a state machine replication protocol, and launching a distributed system based on the state machine replication protocol, according to an embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

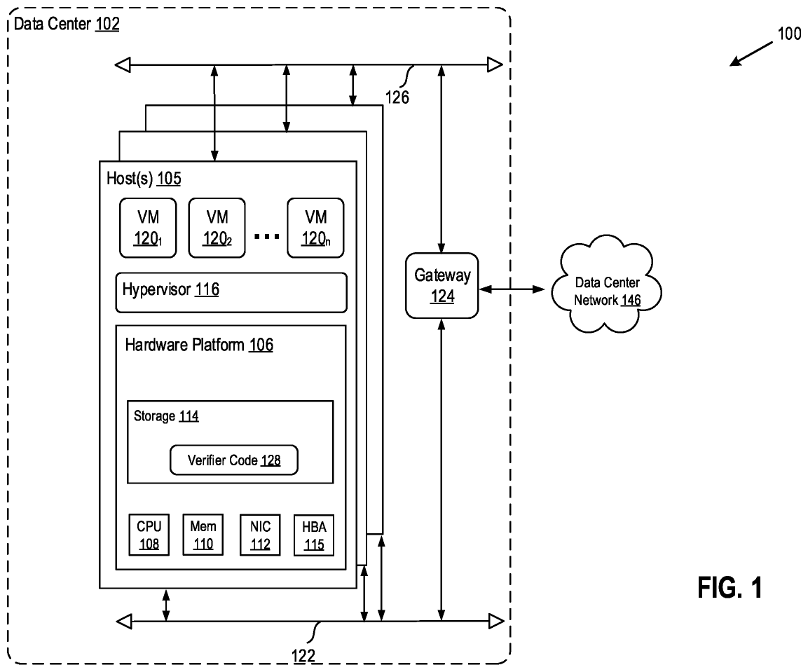

The disclosure provides an approach for modeling and deploying a BFT distributed system, such as a distributed ledger (blockchain) network. FIG. 1 depicts a block diagram of a computer system 100 in which one or more embodiments of the present disclosure may be utilized. Data center 102 may be an on-premise data center or a cloud data center. Data center 102 includes host(s) 105, a gateway 124, a management network 126, and a data network 122. Although the management and data network are shown as separate physical networks, it is also possible in some implementations to logically isolate the management network from the data network using different virtual local area network (VLAN) identifiers. Each of hosts 105 may be constructed on a server grade hardware platform 106, such as an x86 architecture platform. For example, hosts 105 may be geographically co-located servers on the same rack or on different racks in any arbitrary location in datacenter 102.

Host 105 is configured to provide a virtualization layer, also referred to as a hypervisor 116, that abstracts processor, memory, storage, and networking resources of hardware platform 106 into multiple virtual machines 1201 to 120n (collectively referred to as VMs 120 and individually referred to as VM 120). VMs on the same host 105 may run concurrently. Although the disclosure teaches techniques with reference to VMs, the techniques may also be performed by using other virtual computing instances (VCIs), such as containers, Docker containers (see, e.g., www.docker.com), data compute nodes, isolated user space instances, namespace containers, and the like.

Hypervisor 116 architecture may vary. In some embodiments, a virtualization software can be installed as system level software directly on the server hardware (often referred to as “bare metal” installation) and be conceptually interposed between the physical hardware and the guest operating systems executing in the virtual machines. Alternatively, the virtualization software may conceptually run “on top of” a conventional host operating system in the server. In some implementations, hypervisor 116 may comprise system level software as well as a “Domain 0” or “Root Partition” virtual machine, which is a privileged machine that has access to the physical hardware resources of the host. In this implementation, a virtual switch, virtual tunnel endpoint (VTEP), etc., along with hardware drivers, may reside in the privileged virtual machine. One example of hypervisor 116 that may be used is a VMware ESXi™ hypervisor provided as part of the VMware vSphere® solution made commercially available from VMware, Inc. of Palo Alto, California.

Hardware platform 106 of each host 105 may include components of a computing device such as one or more processors (CPUs) 108, system memory 110, a network interface 112, storage system 114, a local host bus adapter (HBA) 115, and other I/O devices such as, for example, a mouse and keyboard (not shown). CPU 108 is configured to execute instructions, for example, executable instructions that perform one or more operations described herein and that may be stored in memory 110 and in storage 114. Network interface 112 enables host 105 to communicate with other devices via a communication medium, such as data network 122 and/or management network 126. Network interface 112 may include one or more network adapters or ports, also referred to as Network Interface Cards (NICs), for connecting to one or more physical networks. In certain embodiments, data network 122 and management network 126 may be different physical networks as shown, and the hosts 105 may be connected to each of the data network 122 and management network 126 via separate NICs or separate ports on the same NIC. In certain embodiments, data network 122 and management network 126 may correspond to the same physical network, but different network segments, such as different subnets or different logical VLAN segments.

System memory 110 is hardware allowing information, such as executable instructions, configurations, and other data, to be stored and retrieved. Memory 110 is where programs and data are kept when CPU 108 is actively using them. Memory 110 may be volatile memory or non-volatile memory. Host bus adapter (HBA) couples host 105 to one or more external storages (not shown), such as a storage area network (SAN) or distributed virtual SAN. Other external storages that may be used include network-attached storage (NAS) and other network data storage systems, which may be accessible via NIC 112.

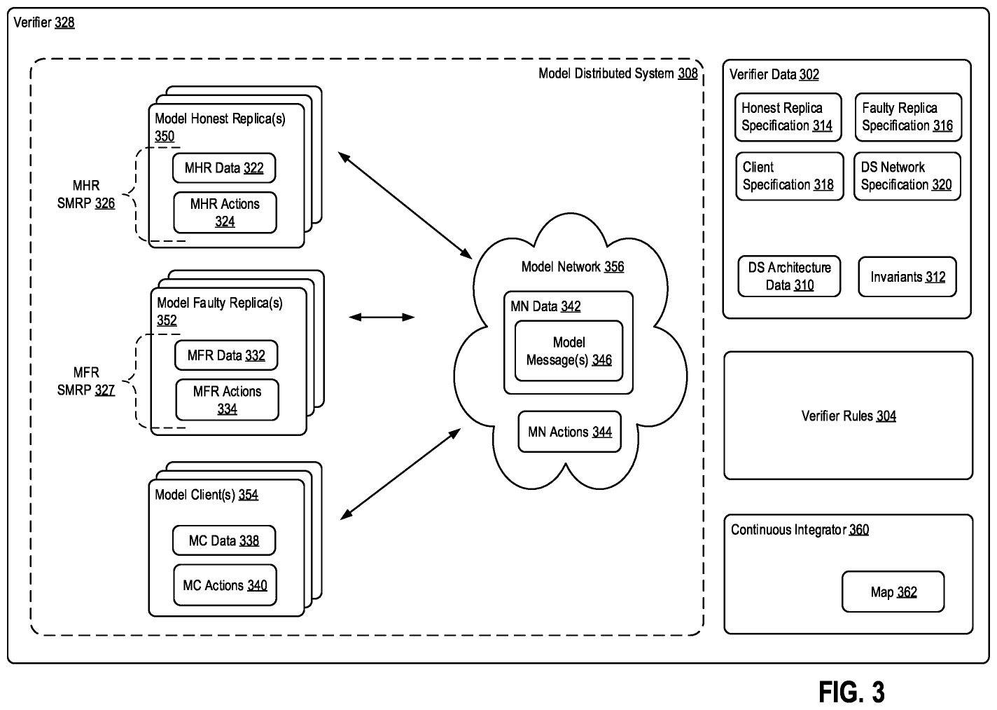

Storage system 114 represents persistent storage device(s). Storage 114 includes verifier code 128, which can be used to instantiate a verifier 328 (see FIG. 3), optionally within one or several VMs 120. Storage disks of storage 114 may be one or more hard disks, flash memory modules, solid state disks, and/or optical disks. Data on storage disks of storage 114 may be organized into blocks, such as through a content-addressable storage (CAS) system, and each block on storage system 114 may be addressable. Although storage 114 is shown as being local to host 105, storage 114 may be external to host 105, such as by connection via HBA 115.

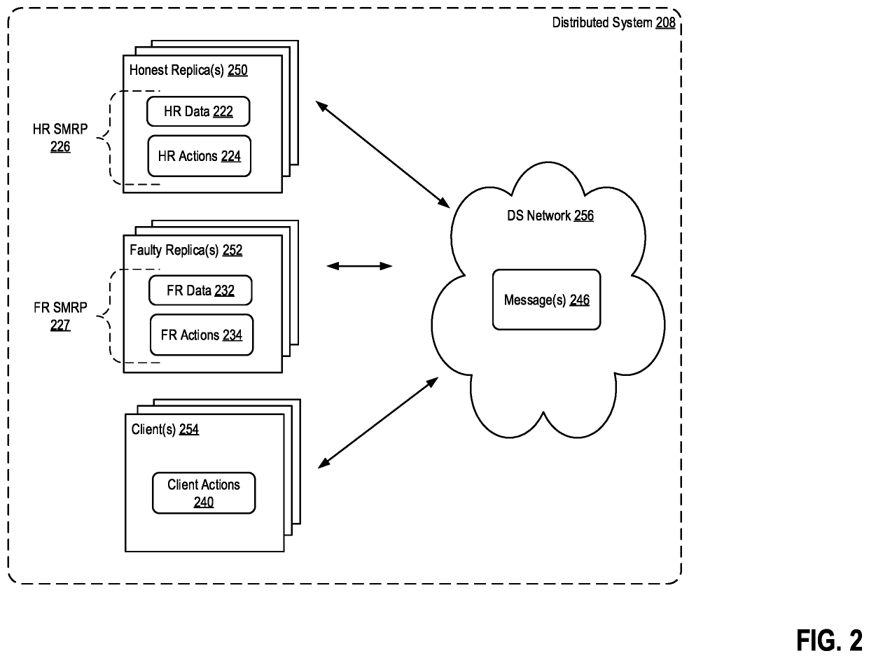

FIG. 2 depicts a block diagram of a distributed system 208, according to an embodiment. Distributed system 208 comprises distributed system network 256, honest replicas 250, faulty replicas 252, and clients 254. In an embodiment, replicas 250/252 and clients 254 are physical hosts, such as hosts 105, comprising storage, processor, memory, and a network connection. Replicas 250/252 may be located within the same data center 102 or within separate data centers 102. In another embodiment, replicas 250/252 are virtualized hosts such as VCIs or VMs 120 running within the same or different host 105.

Honest replica 250 comprises state machine replication protocol (SMRP) 226. Honest replica SMRP 226 comprises honest replica data 222 and honest replica actions 224. Honest replica actions 224 may be thought of as “state transitions” of honest replica SMRP 226, while honest replica data 222 may be thought of as the “state” of honest replica SMRP 226. A state transition in replica SMRP 226/227 leads to a state transition in distributed system 208 if the state transition of replica SMRP 226/227 is accepted by or synchronized with a quorum of replicas 250/252 through the consensus process. SMRP 226 of honest replicas 250 differs from SMRP 227 of faulty replicas 252 in that honest replicas 250 will (a) not output corrupt information to other replicas 250/252 or to clients 254, (b) will not go offline or disappear from the distributed system 208, and (c) will output information when an output of information is expected, such as during consensus voting for distributed system 208.

Honest replica data 222 contains state data of honest replica 250. When distributed network 208 reaches consensus, at least a quorum of replicas 250/252 contains the same data 222/232, and ideally, all replicas 250/252 contain the same data 222/232. A “quorum” can be defined in two separate ways.

A quorum can be defined by the formula Q (quorum)=F+1, where F is the maximum number of faulty replicas in distributed system 208. This quorum guarantees that at least one replica 226/227 is honest. This quorum is sufficient for client 254 to know that it received a correct reply from replica 226/227, for example, for a read request. The F+1 quorum formula guarantees that at least one replica 226/227 is honest. This quorum is sufficient for client 254 to know that client 254 received a correct reply from replicas 226/227 for a read request, for example. This quorum size guarantees that an external entity will get a valid answer to a read request, because at least one of the replying replicas will be honest. This quorum does not guarantee that the answer will be the most recent. This quorum is also used for non-safety related, but liveness related reasoning in replicas 226/227.

A quorum can also be defined by the formula Q=2F+1. This quorum can be used for all decisions replicas 226/227 must reach. This quorum guarantees that at least F+1 honest replicas have reached the necessary protocol stage.

Honest replica actions 224 of honest replica 250 define the actions that honest replica 250 may take. These actions may include “send message,” “receive message,” and “update state.” A “send message” action may include sending a message to a single replica 250/252 or client 254, or may include broadcasting a message to one more than one replica 250/252 or client 254. A “send message” action may also include packaging a number of received messages into a single message, and sending/broadcasting the packaged message. A “receive message” action may or may not result in an update to honest replica data 222. For example, if a client sends a “read” instruction to honest replica 250, then honest replica 250 may reply without updating honest replica data 222. An “update state” action involves changing a value within honest replica data 222. Sending a message does not update the state (data 222) of honest replica 250.

Faulty replica 252 comprises SMRP 227. Faulty replica SMRP 227 comprises faulty replica data 232 and faulty replica actions 234. Faulty replica actions 234 may be thought of as “state transitions” of faulty replica SMRP 227, while faulty replica data 232 may be thought of as the “state” of faulty replica SMRP 227. Similarly to honest replica data 222, sending a message by faulty replica 252 does not update its state (data 232).

Faulty replicas 252 differ from honest replicas 250 in that faulty replicas 252 can behave arbitrarily. Faulty replicas 252 might attempt to perform any action at any time. For example, faulty replicas 252 might (a) output corrupt information to other replicas 250/252 or to clients 254, (b) go offline or disappear from the distributed system 208, or (c) not necessarily output information when an output of information is expected by replicas 250/252 or clients 254, such as during consensus voting for distributed system 208. Corrupt actions by faulty replicas 252 might not succeed in being accepted by other replicas. For example, if a faulty replica 252 tries to impersonate another replica 250/252, the impersonation attempts might be noticed or flagged through encryption mechanisms, such as certificates or transport layer security (TLS) on distributed system network 256.

Similarly to honest replica data 222, faulty replica data 232 contains state data of faulty replica 252. Faulty replica actions 234 of faulty replica 252 define what actions faulty replica 252 may take. However, because faulty replica 252 is “faulty,” the actions it may take can be corrupt or arbitrary. Faulty replica actions 234 are a superset of honest replica actions 224, because faulty replica actions 234 include all actions within honest replica actions 224, and also include arbitrary actions.

Client 254 may be a user computer, such as host 105 or VM 120. Client 254 comprises client actions 240, which are a set of actions that the client may take in relation to replicas 250/252. Client actions 240 may include actions such as “send” and “receive” message. Client actions 240 may also update data stored in its memory or storage, if necessary. Client 254 sends message(s) 246 to replicas 250/252 via distributed system network 256. Messages 246 from clients 254 may result in an action 224/234 by a replica 250/252, and that action may result in an update of data 222/232, such as in the case of a “write” operation within sent message 246. Therefore, client messages 246 can be charactered as initiating state transitions within SMRP 226/227, and then through consensus, in distributed system 208. Clients 254 generate client operations (messages 246) and send them to replicas 250/252 to replicate through the consensus mechanism of SMRP 226/227. An example of a message sent by client 254 to replica 250/252 is a request to change the value of some data within data 222/232. Clients 254 may receive messages from replicas 250/252, such as for example, confirmation messages confirming that a requested action by a client was successfully completed.

Distributed system network 256 may be a network such as data center network 146, and may comprise standard hardware such as switches, routers, etc. In another embodiment, distributed system network is a virtual network, such as a virtual network connecting VMs 120 within host 105.

In an embodiment, distributed system network 256 is an asynchronous network. In another embodiment, distributed system network 256 is a partially synchronous network. Distributed system network 256 comprises messages 246 sent by replicas 250/252 and clients 254. Distributed system network 256 comprises a queue of messages 246 while messages 246 are in transit between honest replicas 250 and faulty replicas 252, or between replicas 250/252 and clients 254. Given that distributed system network 256 may be asynchronous or partially synchronous, messages 246 may arrive at their destination in any order and/or with a delay. In an embodiment, messages 246 are encrypted by the sender (replicas 250/252 or clients 254). The encryption prevents replicas 250/252 and clients 254 from impersonating each other.

FIG. 3 depicts a block diagram of a verifier 328, according to an embodiment. Verifier 328 may be instantiated by running verifier code 128. Verifier 328 may run within a VCI, such as VM 120, or on an operating system outside of a VCI directly on a host, such as host 105. Verifier 328 may be instantiated to formally verify honest replica SMRP 226 of distributed system 208.

Verifier 328 comprises verifier data 302, verifier rules 304, continuous integrator 360, and model distributed system 308. Verifier 328 simulates, reasons through, or models the performance of distributed system 208 by breaking down behavior of distributed system 208 into specifications 314/316/318/320, so as to simulate distributed system 208 as model distributed system 308, and to verify that distributed system 208 is byzantine fault tolerant. Verifier 328 models distributed system 208 by referencing verifier data 202 and specifications 314/316/318/320. Verifier 328 models by using verifier rules 304. During steps of the modeling process, verifier 328 verifies that model distributed system 308 is byzantine fault tolerant by checking whether invariants 312 stay true during the modeling process. As long as specifications 314/316/318/320 accurately specify the code base of honest replica SMRP 226, the behavior of clients 254, and behavior of distributed system network 256, then the result of modeling by verifier 328 is likely to have a high degree accuracy. In an embodiment, verifier 328 may be built using Dafny. See Ford, Richard L., and K. Rustan M. Leino. “Dafny Reference Manual.” (2017); see also K. R. M. Leino, “Accessible Software Verification with Dafny,” in IEEE Software, vol. 34, no. 6, pp. 94-97, November/December 2017, doi: 10.1109/MS.2017.4121212.

A reason for the formally verification of honest replica SMRP 226 is that it can be difficult to determine whether honest replica SMRP 226 is byzantine fault tolerant before launching it, and testing in production can result in data loss. As stated in the Background section, testing for all byzantine faults is impossible, because faulty replica's 252 arbitrary actions 234 create an infinite spaces of potential faults that can occur while SMRP 226/227 is running. That is why formal modeling is the best method of verifying that a distributed system, such as distributed system 208, is byzantine fault tolerant. Actions described below for model distributed system 308 do not “happen” as in a real distributed system 208. Rather, verifier 328 simulates (i.e., formally verifies) them, reasons through the actions, and reaches conclusions about whether invariants 312 hold or not. The power of modeling is that it can brute force many combinations in an optimized way, so that sequences of behavior can be formally verified as byzantine fault tolerant. This is in contrast to testing, where it would be the developer's responsibility to think of the most clever action an adversary (faulty replica) could possibly do. In the modeling or proof setting, a developer simply specifies that the adversary (faulty replica) can do anything. Verifier 328 will reject (fail to verify) any protocol that verifier 328 can't prove works in the presence of such arbitrary behavior.

Verifier data 302 comprises honest replica specification 314, faulty replica specification, 315, client specification 318, distributed system network specification 320, distributed system architecture data 310, honest replica specification 314, faulty replica specification 316, client specification 318, distributed system network specification 320, and invariants 312. Specifications 314/316/318/320 may be written in computer languages such as C++, C#, Java, or Go. Specifications 314/316/318/320 contain rules that are logical equivalents of their real life counterparts, which are components 250/252/254/242 of FIG. 2.

Honest replica specification 314 is used by verifier 328 to create, model, simulate, or reason through one or more model honest replicas 350. Model honest replica 350 comprises model honest replica SMRP 326, which comprises model honest replica data 322 and model honest replica actions 324. Honest replica specification 314 specifies model honest replica actions 324 that can be taken by model honest replica 350. Honest replica specification 314 is based on honest replica actions 224 of honest replica 250 of FIG. 2. Therefore, model honest replica actions 324 include the same or similar actions as honest replica actions 224 described above for honest replica 250. That is, model honest replica actions 324 may include “send message,” “receive message,” and “update state.”

A “send message” action may include sending model message 346 to a single model replica 350/352 or model client 354, or may include broadcasting model message 346 to one more than one model replica 350/352 or model client 354. A “send message” action may also include packaging a number of received model messages 346 into a single message, and sending/broadcasting the packaged message. A “receive message” action may or may not result in an update to model honest replica data 322. For example, if model client 354 sends a “read” request to model honest replica 350, then model honest replica 350 might reply to model client 354 without updating model honest replica data 322. An “update state” action involves changing a value within model honest replica data 322. Sending a model message 346 does not update the state (data 322/332) of model replicas 350/352.

Exemplary actions 324 possible by model honest replicas 350 include the following:
RecvClientOperation( )—step describes the actions a model replica performs when it receives a Client Operation request. The model primary replica is, in an embodiment, a replica that proposes a total order of operations by sending model messages that bind a client operation to some sequence number in a map structure.
SendPrePrepareStep (seqID: SequenceID)—step describes the actions the a model primary replica will perform in order to trigger the consensus by sending a PrePrepare model message proposing the assignment of a Client Operation to a Sequence ID.
RecvPrePrepareStep( )—step describes the actions taken (inspection and acceptance or rejection of the model message) by each model replica once it receives the proposed assignment of a Client Operation to a Sequence ID in a PrePrepare msg.
SendPrepareStep(seqID: SequenceID)—If a PrePrepare has been accepted by a model replica it will respond with broadcasting a Prepare model message to all peers.
RecvPrepareStep( )—step describing the actions taken (inspection and acceptance or rejection of the model message) when receiving a Prepare model message from any peer model replica.
SendCommitStep(seqID: SequenceID)—once a model replica has collected 2F+1 Prepare model messages from different model replicas for a matching assignment of a Client Operation to a Sequence ID, it will broadcast to every peer a Commit msg.
RecvCommitStep( )—step describes the actions taken by each model replica once it receives a Commit model message from a peer (validation and acceptance/rejection of the model message).
DoCommitStep(seqID: SequenceID)—step describing the internal storage book keeping that model replicas perform once they commit an assignment of a Client Operation to a Sequence ID.
ExecuteStep(seqID: SequenceID)—step describing the execution of Client requests.
SendCheckpointStep(seqID: SequenceID)—step describing the process of sending a Checkpoint model message. Once honest model replicas execute X number of Sequence ID-s they generate such model message containing a summary of the state they have reached. Once a model replica collects 2F+1 Checkpoint model messages for a Sequence ID, it can advance its Working Window to now start at this sequence ID, effectively performing garbage collection by removing the PrePrepare, Prepares and Commits it has received for prior Sequence ID-s.
RecvCheckpointStep( )—step describes the actions an honest model replica performs once it receives a Checkpoint model message.
Advance Working WindowStep(seqID: SequenceID, checkpointsQuorum: CheckpointsQuorum)—step describing the garbage collection and opening new slots for consensus for new Sequence ID-s. This step is associated with collection of 2F+1 Checkpoint model messages for a Sequence Id.
PerformStateTransferStep(seqID: SequenceID, checkpointsQuorum: CheckpointsQuorum)—step describing the action of transferring portions of the state to a model replica that has been disconnected from its pers for long period of time-usually the time for 1 or more Working Window sizes of Sequence ID-s to be committed.
SendReplyToClient(seqID: SequenceID)—step describing the sending of a reply to a client for its associated request, once the sending model replica considers the operation completed.
Leave ViewStep(newView: ViewNum)—step that a model replica takes once it decides that the Primary needs to be replaced, effectively increasing the View inside the local storage of the model replica taking this step. Also a View Change model message is created to be sent to peers to notify them for this internal decision. In an embodiment, changing the view is a mechanism which enables the cluster to change the current model primary replica in case of faulty behavior. A “view” can be defined as the part of formal verification where a given leader or primary model replica exists, and a view transition/change occurs when the primary/leader model replica changes.
SendViewChangeMsgStep( )—step describes the sending of a previously created View Change model message
RecvViewChangeMsgStep( )—step describing the actions a model replica performs to validate a received View Change model message.
SelectQuorumOfViewChangeMsgsStep(viewChangeMsgsSelectedByPrimary: ViewChangeMsgsSelectedByPrimary)—step describing the action taken by a new Primary of collecting a quorum of 2F+1 View Change model messages and putting them in a New View model message to be sent to the peers. Based on this New View model message all necessary assignments of Client Operations to Seq ID-s from prior views will be preserved in the new view.
SendNew ViewMsgStep( )—step describes the sending of a previously created New View model message.
RecvNewViewMsgStep( )—step describing the actions a model replica performs to validate a received New View model message.

Model honest replica data 322 is the state of model honest replica 350. In an embodiment, model honest replica data 322 comprises model messages 346 that passed consensus and received by model honest replica 350 since the start of the modeling process. Contrary to real distributed system 208, model distributed system 308 does not need the notion of a database to prove the safety guarantees of consensus, also the model also has no effective memory restrictions on the size the state can reach. Therefore, it is possible to keep ordered model messages 346 (e.g., copies of the model messages 346) that passed consensus sent by model clients 354 as the state of model replicas 350/352. Effectively, the state (model replica data 322/332) is an infinitely growing map where the key is the sequence ID for which a client model message 346 passed consensus and was ordered. A counter may indicate the highest sequence ID reached with no gaps from the start. During consensus, a quorum of replica data 322/332 is synchronized and made the same before continuation to the next modeling step by verifier 328.

Having modeled state in the above-mentioned way, verifier 328 can optionally model “checkpointing” in the simulation process by making model replicas 322/332 put their entire map of ordered model messages 346 received from model clients 354 in special “checkpoint” model messages 346, and then send these “checkpoint” model messages 346 to other model replicas 350/352. This way, when a model replica 350/352 collects a quorum of “checkpoint” model messages 346 with the same state in them, the model replica 350/352 can consider the state stable, effectively collecting a stable checkpoint.

In an embodiment, verifier 328 simulates the presence of a “leader” or “primary” model replica 350/352 that collects broadcasted consensus votes from other model replicas 350/352. The leader or primary replica determines if a quorum has been reached, and broadcasts the final state to other model replicas 350/352.

Faulty replica specification 316 is used by verifier 328 to create, model, simulate, or reason through one or more model faulty replicas 352. Verifier 328 can simulate model faulty replicas 352 to perform all actions that model honest replicas 350 can perform, plus additional arbitrary actions. That is, model faulty replica actions 334 is a superset of model honest replica actions 324, with the extra actions comprising arbitrary actions. For example, during consensus, model faulty replica 352 can choose not send a vote model message 346 to other replicas 350/352, or can send dishonest or corrupt consensus vote model messages 346 to other model replicas 350/352. For another example, model faulty replicas 352 can also apply arbitrary changes to their data 332, thus effectively corrupting their local copy of the replicated state (model honest replica data 322). One of the goals of the methods presented herein is to prove that such arbitrary behaviors by a minority of replicas do not affect the state of the majority of honest replicas 350. For another example, in an embodiment, model faulty replica 352 includes “disappear” within its model faulty replica actions 334, to simulate a faulty replica going offline.

Model faulty replica 352 comprises model faulty replica SMRP 327, which comprises model faulty replica data 332 and model faulty replica actions 334. Faulty replica specification 316 specifies model faulty replica actions 334 that can be taken by model faulty replica 352. Faulty replica specification 316 is based on faulty replica actions 234 of faulty replica 252. Therefore, model faulty replica actions 334 are the same or similar to faulty replica actions 234 described above for faulty replica 252. Model faulty replica data 332 is the state of model faulty replica 352, comprising for example, all model messages 346 (e.g., copies of the model messages 346) that passed consensus and were received by model faulty replica 352 since the start of the modeling process.

Within model replicas 350/352, model replica data 322/332 can be thought of as the “state” of model replica SMRP 326/327, and model replica actions 324/334 can be thought of as “state transitions” of model replica SMRP 326/327. A state transition in model replica SMRP 326/327 leads to a state transition in model distributed system 308 if the state transition of model replica SMRP 326/327 is accepted by or synchronized with a quorum of model replicas 350/352 through the modelled consensus process. Model replica SMRP 326/327 is a passive model protocol-if model replica 350/352 does not receive a model message 346, then model replica SMRP 326/327 does not do anything to update its state (data 322/332). Model replicas 350/352 are not aware of which model replicas 350/350 are faulty and which are honest.

Client specification 318 is used by verifier 328 to create one or more model clients 354. Model client 354 comprises model client data 338 and model client actions 340. Client specification 318 specifies model client actions 340 that can be taken by model client 354. Client specification 318 is based on client actions 240 of client 254. Therefore, model client actions 340 are the same as client actions 240 described above for client 254. Model client data 338 is the state of model client 354, and comprises, for example, all messages received from model replicas 350/352. In an embodiment, model clients 354 are not aware which model replicas are honest 350 and which are faulty 352. In an embodiment, model messages 346 sent by model clients 354 are ordered using a sequence identifier.

Distributed system network specification 320 is used by verifier 328 to create model network 356. Model network 356 comprises model network actions 344 and model network data 342. Model network data 342 comprises model messages 346. Distributed system network specification 320 specifies model network actions 344 that can be taken by model network 356. Distributed system network specification 320 is based on possible actions that can be taken by a real network, such as distributed system network 256.

Model network 356 models a real world network 256 that has nodes, some physical connections between the nodes, and that can exchange messages via a shared protocol. Model network 356 models a queue of messages that are in transit. In model network 356, cryptography, such as certificates and TLS, is abstracted away. Cryptography is abstracted away because verifier 328 actually knows which node/component (350/352/354/356) is which, such as which is a model honest replica 350 and which is model faulty replica 352. In real networks, identification between nodes, whether through certificates or TLS, is needed, but in the model, cryptography is represented by the presence of a trusted arbiter-model network 356, which can provide information regarding whether a given message from any model replica 350/352 really originated from model network 356.

Model network 356 provides information to verifier 328 during modeling the receiving of messages by model replicas 350/352 and clients 354. Every time verifier 328 models the receipt of model message 346 by replica 350/352 or client 354, verifier may check model network data 342 to see if the given model message 346 is within a set of previously sent model messages 346 within model network data 342. If yes, then the receiving is allowed. Otherwise, the receiving is not allowed, because cannot receive a model message 346 that was not previously sent. This is so that verifier 328 reasons about the receiving and sending of messages in a realistic way. Model network 356 has state, which is the set of model messages 346, and a set of state transitions, which is model network actions 344.

Model message 346 may be different from a real message 246 in that a model message may specify the bounds of what the model message 346 can contain, rather than actually containing a distinct message. For example, verifier 328 might assume that a model message 346 from model faulty replica 352 is byzantine in order to model the worst case scenario. In an embodiment, model message 346 may be associated with a sequence identifier to preserve ordering of messages added to model network data 342. It is important to note that no actual messages are sent within model distributed system 308. Rather, messages are simulated or modeled.

Model network actions 344 may include “receive,” “delay,” and “deliver” actions. A “receive” action models the addition of a message to model network 356, such as when verifier 328 models a message that is in transit between model replicas 350/352 and/or model clients 354. The “receive” action may be modeled by adding a model message 346 to model network data 342. A “delay” action models a delayed model message that may occur on a partially synchronous or asynchronous network, such as on distributed system network 256. A “delay” action may be modeled by not delivering a model message 346 to its destination during the current step of the simulation. A “delivery” action models the delivery of a message, such as by the addition of one of model messages 346 to data 322/332/338 of its destination replica or client, and optionally by removal of model message 346 from model network data 342.

Distributed system architecture data 310 defines architecture of model distributed system 308, based on architecture of distributed system 208. Distributed system architecture data 310 can be thought of as the “assumptions” made by verifier 328 about replicas 250/252, distributed system network 256, and SMRPs 226/227 during the modeling process. For example, distributed system architecture data 310 may include information such as:
exact or approximate number of model honest replicas 350 within model distributed system 308
exact or approximate number of model faulty replicas 352
exact or approximate number of model clients 354
maximum ratio of model faulty replicas to total model replicas 350/352 (e.g., maximum value of F provided N using formulas N=3F+1, N=2F+1, or N=F+1, where N=total model replicas 350/352 and F=number of model faulty replicas 352)
model honest replica 350 cannot convert into model faulty replica 352 during modeling
model faulty replica 352 can perform any action except impersonate another model replica 350/352, send model messages 346 on behalf of other model replicas 350 or model clients 354, or convert into model honest replica 350

During reasoning about model distributed system 308, verifier 328 is aware of which model replicas are honest 350 and which are faulty 352, such as by referencing distributed system architecture data 310. In an embodiment, distributed system architecture data 310 is immutable once a simulation starts. In another embodiment, distributed system architecture data 310 is dynamic and can change, such as if model honest replica 350 turns into an model faulty replica 352 or vice versa.

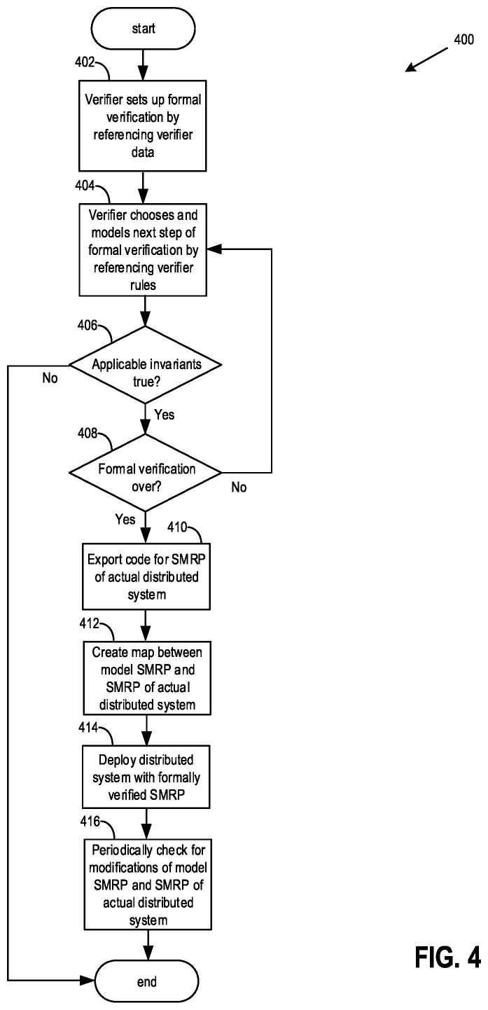

Verifier 328 verifies that all applicable invariants 312 hold true during and/or at the conclusion of each step of the simulation. A “step” in the simulation is encompassed by blocks 404 and 406 of FIG. 4. Verifier 328 is aware of which invariants 312 need to be checked under which conditions, and optionally only checks those invariants that apply for a given step. For example, different invariants may apply if verifier 328 models an action by model faulty replica 352 as opposed to by model honest replica 350.

Verifier 328 comprises invariants 312. Invariants 312 are conditions or relations that must to hold true during the simulation always or under a given set of circumstances. The circumstance may be, for example, while verifier 328 is modeling the broadcast of a message by a replica, or while other circumstances exist or do not exist during the simulation. If any of the invariants are false when they should be true, then model distributed system 308 and model honest replica SMRP 326 are not byzantine fault tolerant. If any of the invariants are false when they should be true, verifier 328 stops the simulation. Examples of invariants include:
the maximum number of model faulty replicas must never rise above one-third of total model replicas 350/352, as defined by the 3F+1=N formula
model messages received by replica 350/352, and thereafter stored in replica data 322/332 must have first come through model network 356
no conflicting consensus votes (sent via model messages 346) may be sent by model honest replicas 350 while consensus of model distributed system 308 is in progress
a quorum of replicas 350/352 must have the same data 322/332
RecordedNew ViewMsgsAreValid(c, v)—statement regarding all model honest replicas that they only store valid New View model messages. The validity check is inside the valid method of the New ViewMsg data type.
RecordedPreparesHaveValidSenderID(c, v)—statement regarding all model honest replicas that they only store Prepare model messages with valid sender ID-s placed in the header.
RecordedPrePreparesRecvdCameFromNetwork(c, v)—statement regarding all honest model replicas that they only record PrePrepares from the network—effectively this statement establishes the recorded PrePrepare model messages as a subset of the ones that are stored in the model network.
RecordedPreparesRecvdCameFromNetwork(c, v)—statement regarding all model honest replicas that they only record Prepares from the network-effectively this statement establishes the recorded Prepare model messages as a subset of the ones that are stored in the network.
RecordedPrePreparesMatchHostView(c, v)—statement regarding all model honest replicas that they only store PrePrepare model messages for the View they are currently in.
RecordedPreparesMatchHostView(c, v)—statement regarding all model honest replicas that they only store Prepare model messages for the View they are currently in.
EveryCommitMsgIsSupportedByAQuorumOfPrepares(c, v)—statement regarding all model honest replicas that they only send a Commit model message if they have previously received and stored 2F+1 Prepapre msgs matching the PrePrepare they have received and stored for the given assignment of a Client operation to a Sequence ID.
RecordedPreparesClientOpsMatchPrePrepare(c, v)—statement regarding all model honest replicas that they only store Prepare model messages matching the previously stored PrePrepare model message.
RecordedCommitsClientOpsMatchPrePrepare(c, v)—statement regarding all model honest replicas that they only store Commit model messages matching the previously stored PrePrepare model message
EverySentIntraViewMsgIsInWorkingWindowOrBefore(c, v)—statement regarding all model honest replicas that they only send PrePrepares, Prepare and Commit model messages up to the end of their Working Window and not beyond.
EverySentIntraViewMsgIsForAViewLessOrEqualToSenderView(c, v)—statement regarding all model honest replicas that they only send PrePrepares, Prepare and Commit model messages for the View they are in and thus in the network there can be such model model messages for a View lower or equal to each model honest replica's View.
EveryPrepareClientOpMatchesRecordedPrePrepare(c, v)—statement regarding the Prepare model messages accumulated in the network, if they originated from an honest sender then they have to match the recorded PrePrepare in this sender.
EveryCommitClientOpMatchesRecordedPrePrepare(c, v)—statement regarding the Commit model messages accumulated in the network, if they originated from an honest sender then they have to match the recorded PrePrepare in this sender.
HonestReplicasLockOnPrepareForGivenView(c, v)—statement regarding all honest replicas that they only accept from each peer 1 Prepare and lock on it for a given Sequence ID and View
HonestReplicasLockOnCommitForGivenView(c, v)—statement regarding all honest replicas that they only accept from each peer 1 Commit and lock on it for a given Sequence ID and View
CommitMsgsFromHonestSendersAgree(c, v)—statement regarding all model honest replicas that the Commit model messages they send for a given View are in agreement regarding the assignment of Client operation to Sequence ID.
RecordedCheckpointsRecvdCameFromNetwork(c, v)—statement regarding all model honest replicas that the only source of the Checkpoint model messages they receive and store is the network, effectively the network delivers previously send model messages from model peer replicas.
UnCommitableAgreesWithPrepare(c, v)—the predicate states that model honest replicas preserve what has been committed in prior views and do not vote for something that can corrupt the history of committed operations even if multiple View Changes happens in the system.
UnCommitableAgreesWithRecordedPrePrepare(c, v)/Unfinished proof.—the predicate states that model honest replicas preserve what has been committed in prior views and do not accept a PrePrepare for something that can corrupt the history of committed operations even if multiple View Changes happens in the system.
HonestReplicasLeaveViewsBehind(c, v)—statement regarding all model honest replicas that once they leave a given View, they no longer send model messages for it.
RecordedNewViewMsgsContainSentVCMsgs(c, v)—statement regarding all model honest replicas that they only put View Change model messages actually sent from a model peer replica or themselves into the New View model message they generate.
RecordedViewChangeMsgsCameFromNetwork(c, v)—statement regarding all model honest replicas that the recorded View Change model Messages in their internal storage are a subset of the ones in the network.
SentViewChangesMsgsComportWithSentCommits(c, v)—model honest replicas insert the Prepare certificates (quorums of 2F+1 Prepares for a given Sequence ID) they have in the View Change model messages they generate on leaving a View.
RecordedViewChangeMsgsAreValid(c, v)—statement regarding all model honest replicas that they only store valid View Change model messages. The validity check is inside the valid method of the ViewChangeMsg data type.
TemporarilyDisableCheckpointing(c, v)—since the proof is a work in progress, we temporarily disable checkpointing, even though the model supports it
EveryCommitMsgIsRememberedByItsSender(c, v)—statement regarding all model honest replicas that establishes the connection between a sent Commit model message and the presence of a Prepared certificate in the model replica that sent the Commit's internal storage.

Verifier rules 304 are rules followed by verifier 328 when simulating model distributed system 308. Verifier rules 304 track potential actions that can be taken within distributed system 208, so that model distributed system 308 resembles a real life distributed system. For example, rules within verifier rules 304 may include:
Steps (see FIG. 4) taken by verifier 328 are modeled as atomic steps. Verifier 328 models actions 324/334/340/344 such that a time gap is modeled to be present between the actions.
Only one component 350/352/354/356 of model distributed system 308 can take actions (e.g., send message, receive message, perform internal state modification, etc.) 324/334/340/344 at a given time.
Initiate formal verification with a model message 346 from one of model clients 354
Initiate consensus mechanism after replica data 322/332 has changed in one or more model replicas 350/352
Initiate formal verification (block 406 of FIG. 4) after verifier has completed a step in the simulation

Continuous integrator 360 may be a component of verifier 328 or a separate software executing separately from verifier 328, such as within storage 114 on the same or different VM 120 or host 105. Continuous integrator 360 executes periodically or is invoked manually after initial formal verification by verifier 328 has completed. Continuous integrator 360 references map 362 to check whether changes have been made either in model honest replica SMRP 326 or honest replica SMRP 226. Map 362 may be a data structure such as a table that maps logical components of model honest replica SMRP 326 to honest replica SMRP 226. For example, map 362 may map model honest replica actions 324 to lines of code of honest replica SMRP 226 or to actions 224 of honest replica 250. Map 362 may be a component of continuous integrator 360, or may be a separate file stored separately from continuous integrator 360.

If continuous integrator 360 notices a change in the code for honest replica SMRP 226 after initial verification has been completed, continuous integrator 360 may do one or more of a number of actions. The actions may include (a) surfacing a notification to a human operator or another software program that the change in honest replica SMRP 226 might mean that the previous verification of SMRP 226 is no applicable, and SMRP 226 needs to be reverified, or (b) automatically modifying model honest replica SMRP 326 to match the change in SMRP 226, and optionally also automatically running verifier 328 to reverify the modified model honest replica SMRP 326 and thereby also verifying honest replica SMRP 226.

If continuous integrator 360 notices a change in the code for model honest replica SMRP 326 after initial verification has been completed, continuous integrator 360 may do one or more of a number of actions. The actions may include (a) surfacing a notification to a human operator or another software program that a corresponding change in model honest replica SMRP 326 is need, or (b) automatically verifying model honest replica SMRP 326, and if verification passes, notifying a human operator or automatically modifying honest replica SMRP 226 to match the code of model honest replica SMRP 326.

FIG. 4 depicts a flow diagram of a method 400 of formally verified byzantine fault tolerance of a state machine replication protocol 226, and launching a distributed system 208 based on the state machine replication protocol, according to an embodiment.

At block 402, verifier 328 sets up model distributed system 308 by referencing verifier data 302. Verifier 302 references distributed system architecture data 310 to determine the number/ratio of honest and faulty replicas 350/352, and to determine other information as described above with reference to data 310, that is to be simulated in the model. After or simultaneously, verifier references specifications 314/316/318/320 to create one or more model honest replicas 350, one or more model faulty replicas 352, one or more model clients 354, and one or more model networks 356. Rather than creating a specific or approximate number of model replicas 350/352, verifier 328 may instead define a ratio, max ratio, or a range of ratio values of model honest replicas 350 to model faulty replicas 352, and then reason through the steps of the simulation in light of the ratio, max, ratio, or range of ratio values.

At block 404, verifier 328 references verifier rules 304 to initiate or take the next step of the simulation. For example, as the first step of the simulation, verifier 328 may choose a model client action 340 to initiate modeling of a “send” action from model client 354 to one of model replicas 350/352. For another example, after verifier 328 models the action of updating model data 322/332, then verifier 328 might initiate the step of modeling consensus among model replicas 350/352 so as to model the synchronization of model replica state (data 322/332) among model replicas 322/332. As described above, modeling an action that results in updating state (data 322/332) of model replica SMRP 326/327 results in a state transition of model replica SMRP 326/327.

At block 406, verifier 328 chooses invariants that apply to the current conditions, and checks whether those conditions are true. If all variants 312 checked are true, then method 400 continues to block 408. If any of the invariants 312 checked are false, then verifier 328 stops the simulation and method 400 ends. Optionally, before ending simulation, verifier 328 takes note of the false invariants 312, the conditions under which the false variants 312 occurred, and exports this data into a file.

At block 408, verifier 328 checks whether the simulation is over, or if additional steps are to be taken in the simulation. If simulation is not over, then verifier 328 returns to block 404 to choose the next step of the simulation. If simulation is over, and no invariants were determined to be false at block 406, then model honest replica SMRP 326 has been formally verified and is ready to be used in a real distributed network, such as distributed network 208. Optionally, verifier 328 exports some or all invariants 312. If simulation is over, then method 400 continues to block 410. The simulation is over once the verifier formally verifies that for every possible state for which the invariant holds, if an action is taken by a model honest replica, model faulty replica or model client step to reach the next state of distributed system 308, the invariant will hold in that next step as well.

At block 410, verifier 328 exports state machine replication protocol code, such as honest replica SMRP 226 code for use in a real distributed network. The export may be to a file. The exported code is byzantine fault tolerant. The exported code is based on model honest replica SMRP 326 and/or on honest replica specification 314. The exported code may be in one of various computer languages such as C++, C#, Java, or Go. Block 410 is optional, because honest replica SMRP 226 may have been created before model honest replica SMRP 326, and model honest replica SMRP 326 was manually created to be logically equivalent to SMRP 226 for verification purposes.

At block 412, verifier 328 creates and stores map 362, which maps sections/actions/lines of code/components of model honest replica SMRP 326 to sections/actions/lines of code/components of honest replica SMRP 226. As discussed above, map 362 may be a table.

At block 414, distributed system 208, or a similar distributed system, is deployed using SMRP 226 from block 410. Deployed distributed system 208 is based on SMRP 226 from block 410, which was formally verified through simulating model honest replica SMRP 326 by verifier 328 in blocks 402 through 410 of method 400, as described above. If the formally verified SMRP 226 is logically equivalent to model honest replica SMRP 326, then formally verified SMRP 326/226 can be considered byzantine fault resilient to a high degree of trust. Deployed distributed system 208 may be deployed centrally by a single actor or a group of cooperating actors. Or, deployed distributed system 208 may be deployed in a decentralized manner, such that a single actor deploys a single replica 250 implementing SMRP 226, and connects the deployed replica 250 to other deployed replicas 250/252 through a network, such as network 256. After block 412, method 400 ends.

At block 416, after the initial verification, continuous integrator 360 executes periodically or is invoked manually to reference map 362 and check whether changes have been made either in model honest replica SMRP 326 or honest replica SMRP 226. As discussed above, if continuous integrator 360 notices a change in the code for honest replica SMRP 226 or in model honest replica SMRP 326 after initial verification has been completed, then continuous integrator 360 may perform a number of actions, such as notify a human operator or another software program, reverify model honest replica SMRP 326, and/or automatically modify the unchanged SMRP to match changes in the other.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of deploying a distributed system that implements a state machine replication protocol, the method comprising:
simulating a model distributed system that implements a first state machine replication protocol;
choosing an action by one of model components of the model distributed system to cause a state transition of the model distributed system;
verifying the first state machine replication protocol by verifying that one or more invariants are true in the model distributed system after the state transition;
creating a map connecting actions of the first state machine replication protocol and lines of code of a second state machine replication protocol;
deploying a distributed system that implements the second state machine replication protocol; and
referencing the map to either (a) modify the second state machine replication protocol responsive to one or more changes in the first state machine replication protocol, or (b) modify the first state machine replication protocol responsive to one or more changes in the second state machine replication protocol.

2. The method of claim 1, further comprising creating, after the verifying, code that implements the second state machine replication protocol, wherein the code that implements the second state machine replication protocol is logically equivalent to code that implements the first state machine replication protocol.

3. The method of claim 2, wherein the creating comprises exporting, by the verifier, code that implements the first state machine replication protocol from which the code that implements the second state machine replication protocol is derived.

4. The method of claim 1, wherein the one of the model components is at least one of a model honest replica, a model faulty replica, a model client, or a model network.

5. The method of claim 4, wherein a sum total of model honest replicas and model faulty replicas is equal to three multiplied by a number of faulty replicas plus one.

6. The method of claim 4, wherein actions of the one or more model faulty replicas comprise arbitrary actions.

7. The method of claim 4, wherein the state of the one or more model honest replicas is defined by model messages received by the one or more model honest replicas during the simulation.

8. The method of claim 1, wherein the action is one of send, receive, update, disappear, deliver, or delay.

9. The method of claim 1, wherein the verifier is executing within a virtual computing instance.

10. The method of claim 1, wherein the distributed system is a distributed ledger.

11. A non-transitory computer readable medium comprising instructions to be executed in a processor of a computer system, the instructions when executed in the processor cause the computer system to carry out a method of deploying a distributed system that implements a state machine replication protocol, the method comprising:
simulating a model distributed system that implements a first state machine replication protocol;
choosing an action by one of model components of the model distributed system to cause a state transition of the model distributed system;
verifying the first state machine replication protocol by verifying that one or more invariants are true in the model distributed system after the state transition;
creating a map connecting actions of the first state machine replication protocol and lines of code of a second state machine replication protocol;
deploying a distributed system that implements the second state machine replication protocol; and
referencing the map to either (a) modify the second state machine replication protocol responsive to one or more changes in the first state machine replication protocol, or (b) modify the first state machine replication protocol responsive to one or more changes in the second state machine replication protocol.

12. The non-transitory computer readable medium of claim 11, further comprising creating, after the verifying, code that implements the second state machine replication protocol, wherein the code that implements the second state machine replication protocol is logically equivalent to code that implements the first state machine replication protocol.

13. The non-transitory computer readable medium of claim 12, wherein the creating comprises exporting, by the verifier, code that implements the first state machine replication protocol from which the code that implements the second state machine replication protocol is derived.

14. The non-transitory computer readable medium of claim 11, wherein the one of the model components is at least one of a model honest replica, a model faulty replica, a model client, or a model network.

15. The non-transitory computer readable medium of claim 14, wherein a sum total of model honest replicas and model faulty replicas is equal to three multiplied by a number of faulty replicas plus one.

16. The non-transitory computer readable medium of claim 14, wherein actions of the one or more model faulty replicas comprise arbitrary actions.

17. The non-transitory computer readable medium of claim 14, wherein the state of the one or more model honest replicas is defined by model messages received by the one or more model honest replicas during the simulation.

18. The non-transitory computer readable medium of claim 11, wherein the action is one of send, receive, update, disappear, deliver, or delay.

19. The non-transitory computer readable medium of claim 11, wherein the verifier is executing within a virtual computing instance.

20. A computer system comprising:
a first processor programmed to perform a simulation that includes the steps of:
simulating the model distributed system that implements the first state machine replication protocol;
choosing an action by one of the model components of the model distributed system to cause a state transition of the model distributed system; and
verifying the first state machine replication protocol by verifying that one or more invariants are true in the model distributed system after the state transition;
creating a map connecting actions of the first state machine replication protocol and lines of code of a second state machine replication protocol;
referencing the map to either (a) modify the second state machine replication protocol responsive to one or more changes in the first state machine replication protocol, or (b) modify the first state machine replication protocol responsive to one or more changes in the second state machine replication protocol;
a second processor programmed to deploy a distributed system that implements the second state machine replication protocol.
